(19) United States
(12) Patent Application Publication
(10) Pub. No.: US 2009/0285273 A1
(43) Pub. Date: Nov. 19, 2009

(54) SIGNAL PROCESSING DEVICE, SIGNAL PROCESSING METHOD, AND SIGNAL PROCESSING PROGRAM

(76) Inventor: Tomoji MIZUTANI, Kanagawa (JP)

Correspondence Address: FROMMER LAWRENCE & HAUG LLP, 745 FIFTH AVENUE, NEW YORK, NY, 10151, US

(21) Appl. No.: 12/467,543

(22) Filed: May 18, 2009

(30) Foreign Application Priority Data
May 19, 2008 (JP) P2008-130809

(51) Int. Cl. H04B 1/38

(52) U.S. Cl. 375/220

(57) ABSTRACT

A signal processing device includes an auxiliary data detection unit that detects presence or absence of auxiliary data from an SDI (Serial Digital Interface) signal and outputs a detection signal indicating the presence or absence of auxiliary data, a delay unit that delays the detection signal output from the auxiliary data detection unit by at least one field, a payload identifier control unit that outputs a control signal for controlling provision of payload identifier according to a logical operation with signals including the detection signal output from the auxiliary data detection unit and the detection signal delayed by the delay unit, and a payload identifier provision unit that adds a payload identifier to the SDI signal and outputs the signal if the control signal commands provision, and adds no payload identifier to the SDI signal and outputs the signal as it is if the control signal commands no provision.

### BACKGROUND OF THE INVENTION

1. Field of the Invention

The present invention relates to a signal processing device, a signal processing method, and a signal processing program for providing a payload identifier to an SDI (Serial Digital Interface) signal as one of video signal transmission standards according to need.

2. Background Art

Standards on video technology, SMPTE (Society of Motion Picture and Television Engineers) are standards for synchronization in data transmission of video equipment and audio equipment, and many equipment manufacturers adopt them (see JP-A-2007-013466). Of the standards, SMPTE-352M defines a standard of VPID (Video Payload Identifier).

Here, since VPID is not indispensable in HD (High Definition) and SD (Standard Definition) signal transmission, an SDI signal provided with VPID is not supported in most equipment in the past.

Further, since VPID is indispensable in Dual Link (SMPTE-372M) and 3G-SDI (SMPTE-425M) transmission standards that have been recently set (see Manabu Kuromori, 3D-SDI ni kansuru kikaku no shosai (Details in 3D-SDI standard), Design Wave Magazine 2008 January, CQ Publishing, Jan. 1, 2008, pp. 103-114), it is expected that the equipment handling VPID will be increased while SDI signals with VPID and SDI signals without VPID will be mixed within the broadcasting system for some time. Accordingly, at present, handling of VPID is different in each equipment and, for example, there is equipment that does not identify VPID, outputs an SDI signal with VPID forcibly added thereto, and outputs input VPID in a transparent manner.

### SUMMARY OF THE INVENTION

When a Dual Link or 3G-SDI signal with SDI signal incorporating no VPID slips into the broadcasting system, the normal operation of the broadcasting equipment is hindered. Further, in a particular video format, VPID and LTC (time code) are defined in the same line, and thus, if VPID is forcibly provided to the SDI signal that has incorporated LTC, a problem that LTC is lost and the broadcasting system malfunctions arises.

Thus, there is a need for a technology of appropriately providing VPID to an SDI signal according to need.

An embodiment of the invention is directed to a signal processing device including an auxiliary data detection unit that detects presence or absence of auxiliary data from an SDI (Serial Digital Interface) signal and outputs a detection signal indicating the presence or absence of auxiliary data, a delay unit that delays the detection signal output from the auxiliary data detection unit by at least one field, a payload identifier control unit that outputs a control signal for controlling provision of payload identifier according to a logical operation with signals including the detection signal output from the auxiliary data detection unit and the detection signal delayed by the delay unit, and a payload identifier provision unit that adds a payload identifier to the SDI signal and outputs the signal if the control signal output from the payload identifier control unit commands provision, and adds no payload identifier to the SDI signal and outputs the signal as it is if the control signal commands no provision.

Further, another embodiment of the invention is directed to a signal processing method including the steps of detecting presence or absence of auxiliary data from an SDI signal and outputting a detection signal indicating the presence or absence of auxiliary data, delaying the detection signal by at least one field, outputting a control signal for controlling provision of payload identifier according to a logical operation with signals including the detection signal of the current field based on the SDI signal and the detection signal delayed by a predetermined number of fields, and adding a payload identifier to the SDI signal and outputting the signal if the control signal commands provision, and adding no payload identifier to the SDI signal and outputting the signal as it is if the control signal commands no provision.

Furthermore, yet another embodiment of the invention is directed to a signal processing program allowing a computer to execute the steps of detecting presence or absence of auxiliary data from an SDI signal and outputting a detection signal indicating the presence or absence of auxiliary data, delaying the detection signal by at least one field, outputting a control signal for controlling provision of payload identifier according to a logical operation with signals including the detection signal of the current field based on the SDI signal and the detection signal delayed by a predetermined number of fields, and adding a payload identifier to the SDI signal and outputting the signal if the control signal commands provision, and adding no payload identifier to the SDI signal and outputting the signal as it is if the control signal commands no provision.

In the embodiments, presence or absence of auxiliary data is detected from the SDI signal, the payload identifier is added to the SDI signal and the signal is output if there is no auxiliary data, and no payload identifier is added to the SDI signal and the signal is output as it is if there is auxiliary data. Accordingly, if there is auxiliary data in the SDI signal, the signal is output without losing the data, and, if there is no auxiliary data, payload identifier is added so that equipment at the downstream may deal with the signal.

According to the embodiments of the invention, an appropriate payload identifier can be provided to an SDI signal to which no payload identifier has been provided according to need.

### BRIEF DESCRIPTION OF THE DRAWINGS

FIG. 1 is a block diagram for explanation of a signal processing device according to the first embodiment.

FIG. 2 is a diagram for explanation of a logical operation performed in a VPID control unit of the signal processing device according to the first embodiment.

FIG. 3 is a flowchart for explanation of a flow of a signal processing program according to the embodiment.

FIG. 4 is a block diagram for explanation of a signal processing device according to the second embodiment.

FIG. 5 is a diagram for explanation of a logical operation performed in a VPID control unit of the signal processing device according to the second embodiment.

FIG. 6 is a flowchart for explanation of a flow of a signal processing program according to the embodiment.

FIG. 7 is a block diagram for explanation of an effect switcher device.

FIG. 8 is a block diagram for explanation of an internal configuration of the effect switcher device.

### DESCRIPTION OF THE PREFERRED EMBODIMENTS

Hereinafter, embodiments of the invention will be explained with reference to the drawings. A signal processing device, a signal processing method, and a signal processing program according to the embodiments load an SDI (Serial Digital Interface) signal defined in standards on video technology, SMTPE, and provide VPID (Video payload identifier) of SMPTE-352M to the signal according to need and output it.

VPID is not indispensable in HD-SDI and SD-SDI, but indispensable in Dual Link and 3G-SDI. The insertion location of VPID is defined in SMPTE-352M. Specifically, one VPID is inserted in one field or one frame. The line in which the VPID is inserted is 10-line and 572-line in 1080I (interlace) and 10-line in 720P and 1080P (progressive). VPID is inserted in a horizontal auxiliary area at the immediate downstream of line CRC (Cyclic Redundancy Check) in a data stream of the line.

VPID includes an auxiliary data flag of three words, a data ID, a secondary data ID, the number of data, identification data of four words, and a checksum, and is identification information that defines transmission system (discrimination between interlace and progressive), frame rate, sampling structure, channel identification, dynamic range, bit length, and so on.

In the embodiment, regarding an SDI signal without VPID, whether or not auxiliary data (including VPID) is inserted into a line in a data stream in which VPID is supposed to be provided is detected, if the auxiliary data is contained, the auxiliary data is not destroyed but the signal is output as it is, and if the auxiliary data is not contained, VPID is provided in the location and the signal is output.

### First Embodiment

### <Signal Processing Device>

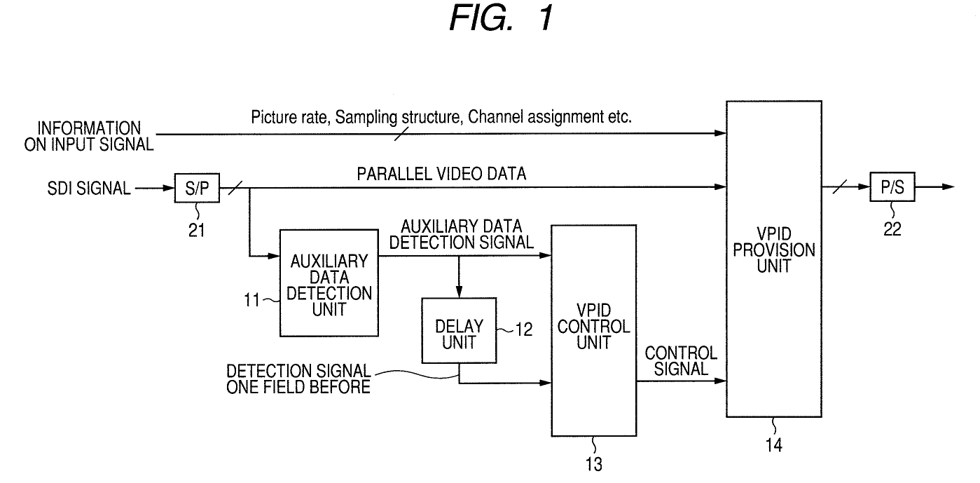

FIG. 1 is a block diagram for explanation of a signal processing device according to the first embodiment. The signal processing device according to the first embodiment mainly includes an auxiliary data detection unit 11, a delay unit 12, a VPID control unit 13, and a VPID provision unit 14. Further, the signal processing device includes a serial-parallel conversion unit 21 that converts an SDI signal as serial video data into parallel video data, and a parallel-serial conversion unit 22 that converts parallel video data output from the VPID provision unit 14 into serial video data.

The auxiliary data detection unit 11 inputs parallel video data converted from the SDI signal by the serial-parallel conversion unit 21, determines whether auxiliary data is contained in the SDI signal or not, and outputs a detection signal indicating the presence or absence of the auxiliary data. Specifically, the unit detects whether or not there is auxiliary data in a predetermined area in a line in a data stream in which VPID is supposed to be inserted in the SDI signal. More specifically, the unit refers to the horizontal auxiliary area at the immediate downstream of line CRC in the data stream of the 10-line and 572-line in 1080I (interlace) and 10-line in 720P and 1080P (progressive). The unit detects whether or not there is auxiliary data in the horizontal auxiliary area and outputs the result as a detection signal. The detection signal is output to the delay unit 12 and the VPID control unit 13.

The delay unit 12 is a circuit that delays the detection signal output from the auxiliary data detection unit 11 by at least one field. In the embodiment, the case of handling interlace video data is mainly illustrated and one-field delay is taken as an example, however, in the case of handling progressive video data, the delay is in units of frames.

The VPID control unit 13 outputs a signal for controlling provision of VPID according to a logical operation with inputs of signals including the detection signal output from the auxiliary data detection unit 11 and the detection signal delayed by the delay unit 12.

The VPID provision unit 14 adds VPID to a predetermined location of the SDI signal (parallel video data as the parallel-converted SDI signal in the embodiment) and outputs it if the control signal output from the VPID control unit 13 commands provision, and adds no VPID to the SDI signal (parallel video data as the parallel-converted SDI signal in the embodiment) and outputs it as it is if the control signal commands no provision.

Further, information representing contents of the VPID to be provided (information on the input signal) is sent to the VPID provision unit 14 when the VPID is provided. The information on the input signal is preset information of specifications of signals handled by the signal processing device and the like including Picture rate, Sampling structure, and Channel assignment, for example. The VPID provision unit 14 determines the contents of the VPID to be provided in conformity of the SMPTE-352M standard according to the information on the input signal.

### <Signal Processing Method>

First, the SDI signal is input to the serial-parallel conversion unit 21 for conversion into parallel video data. Here, in the parallel video data, one frame is configured by the 1st field and the 2nd field. The parallel video data is sent to the VPID provision unit 14 and the auxiliary data detection unit 11.

Then, in the auxiliary data detection unit 11, whether auxiliary data (ANC data: referred to as “ANCI” in the embodiment) of the SDI signal is contained in the sent parallel video data or not is determined. The LTC as a time code is contained in the ANCI. Specifically, whether or not there is auxiliary data in a predetermined area in a line in a data stream in which VPID is supposed to be inserted in the SDI signal is detected. More specifically, whether or not there is auxiliary data in the horizontal auxiliary area is determined by referring to the area at the immediate downstream of line CRC in the data stream of the 10-line and 572-line in 1080I (interlace) and 10-line in 720P and 1080P (progressive).

If detecting ANCI, the auxiliary data detection unit 11 outputs a detection signal indicating the presence of the auxiliary data, and if detecting no ANCI, the unit outputs a detection signal indicating the absence of the auxiliary data. The detection signal is output to the delay unit 12 and the VPID control unit 13.

Then, the delay unit 12 performs processing of delaying the detection signal output from the auxiliary data detection unit 11 by at least one field. In the embodiment, the case of handling interlace video data is mainly illustrated and one-field delay is taken as an example, however, in the case of handling progressive video data, the delay is in units of frames. The detection signal delayed by one field is sent to the VPID control unit 13.

Then, the VPID control unit 13 outputs a control signal for giving a command as to whether VPID is provided or not according to a predetermined logical operation with inputs of signals including the detection signal corresponding to the current field sent from the auxiliary data detection unit 11 and the detection signal delayed by one field sent from the delay unit 12.

Subsequently, the VPID provision unit 14 provides VPID to the parallel video data according to the control signal output from the VPID control unit 13. That is, if the control signal commands provision, the unit provides VPID to the parallel video data. Specifically, VPID is provided to the horizontal auxiliary area (parallel video data corresponding to the horizontal auxiliary area) at the immediate downstream of line CRC in the data stream of the 10-line and 572-line in 1080I (interlace) and 10-line in 720P and 1080P (progressive). On the other hand, if the control signal commands no provision, the unit provides no VPID to the parallel video data and outputs it as it is.

Finally, the parallel video data output from the VPID provision unit 14 is sent to the parallel-serial conversion unit 22, and converted into the SDI signal as a serial signal and output.

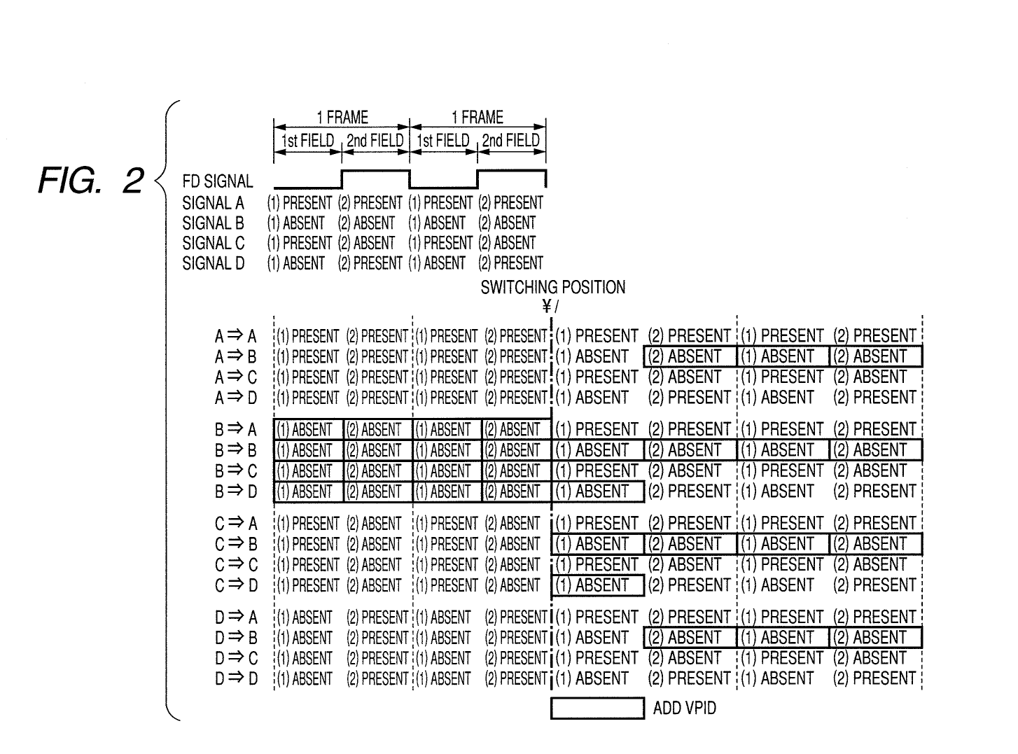

Here, the logical operation performed in the VPID control unit 13 will be explained. FIG. 2 is a diagram for explanation of the logical operation performed in the VPID control unit of the signal processing device according to the first embodiment. Here, the logical operation is for the case of applying the signal processing device according to the embodiment to a switching device that selects and outputs one of input SDI signals.

When the signal is switched in the switching device, there are four types of A to D of SDI signals before switching and SDI signals after switching. Signal A contains ANCI in both the 1st field and the 2nd field forming one frame, signal B contains no ANCI in both the 1st field and the 2nd field, signal C contains ANCI in the 1st field but contains no ANCI in the 2nd field, and signal D contains no ANCI in the 1st field but contains ANCI in the 2nd field.

Accordingly, when the four types of SDI signals are switched in the switching device, it is necessary to consider the total 16 patterns of signal variations from the four types before switching to the four types after switching.

Here, signal A is an SDI signal containing VPID like Dual Link and 3G-SDI, for example, because ANCI is contained in both the 1st field and the 2nd field.

Further, signal B is an SDI signal containing no VPID like HD and SD, for example, because no ANCI is contained in both the 1st field and the 2nd field.

Signal C is an SDI signal containing LTC (time code) in the 1st field, for example, because ANCI is contained in the 1st field but no ANCI is contained in the 2nd field.

Furthermore, signal D contains no ANCI in the 1st field but contains ANCI in the 2nd field, and such a signal is not used at present.

Of the 16 patterns of signal switching, regarding signal A to signal A, signal B to signal B, signal C to signal C, and signal D to signal D, the switching operation is not actually performed but the same signal passes through the switching position. Additionally, when the signal B is input, VPID is added before switching.

In the 16 patterns of switching of SDI signals, the logical operation performed in the VPID control unit 13 of the embodiment is to obtain OR (logical add) of the detection information one field before indicating presence of ANCI (presence of auxiliary data) and the current detection information indicating presence of ANCI (presence of auxiliary data). That is, in the detection information, when the presence of ANCI (presence of auxiliary data) is “1” and the absence of ANCI (absence of auxiliary data) is “0”, if OR (logical add) of the detection information one field before and the current detection information is “0”, the control signal commanding provision of VPID is output. Briefly, VPID is provided only when there is no auxiliary data both one field before and at present.

In the example shown in FIG. 2, VPID is provided in the fields indicated by thick frames. VPID provision in each switching of signals (including passing) is as follows.
From signal A to signal A: no VPID is provided in all fields.
From signal A to signal B: VPID is provided in the 2nd field of the first frame after switching to signal B and the subsequent fields.
From signal A to signal C: no VPID is provided in all fields.
From signal A to signal D: no VPID is provided in all fields.
From signal B to signal A: VPID is provided in signal B before switching.
From signal B to signal B: VPID is provided in all fields.
From signal B to signal C: VPID is provided in signal B before switching.
From signal B to signal D: VPID is provided in signal B before switching and in the 1st field of the first frame after switching to signal D, but no VPID is provided in all of the subsequent fields.
From signal C to signal A: no VPID is provided in all fields.
From signal C to signal B: VPID is provided in the 1st field of the first frame after switching to signal B and the subsequent fields.
From signal C to signal C: no VPID is provided in all fields.
From signal C to signal D: VPID is provided only in the 1st field of the first frame after switching to signal D and no VPID is provided in all of the subsequent fields.
From signal D to signal A: no VPID is provided in all fields.
From signal D to signal B: VPID is provided in the 2nd field of the first frame after switching to signal B and the subsequent fields.
From signal D to signal C: no VPID is provided in all fields.
From signal D to signal D: no VPID is provided in all fields.

In the logical operation, in switching from signal C to signal B, VPID is provided in the 1st field of the first frame after switching and all of the subsequent fields.

On the other hand, in switching from signal A to signal B, no VPID is provided only in the 1st field of the first frame after switching and VPID is provided in all of the subsequent fields. In the equipment at the downstream, if there is no VPID only in the 1st field of the first frame, an error may not be detected.

Further, in switching from signal B to signal D and switching from signal C to signal D, VPID is provided only in the 1st field of the first frame after switching, and in switching from signal D to signal B, no VPID is provided in the 1st field of the first frame after switching. However, it is not necessary to substantially consider the operation results because all of them contain signal D as a subject of switching and signal D is not used at present.

In the above explanation, the case of applying the signal processing device according to the embodiment to the switching device has been taken as an example. In the device without switching (the device with the same types of input and output signals), only the operations in the cases from signal A to signal A, signal B to signal B, signal C to signal C, and signal D to signal D are used in the above logical operations. In all of the cases, if there is ANCI in the input SDI signal, the signal is output as it is without VPID provided (but with ANCI), and if there is no ANCI in the input SDI signal, the signal is output after VPID is provided in the 1st field of the first frame and VPID is provided in all of the subsequent fields.

### <Signal Processing Program>

The signal processing method according to the embodiment may not only be executed as a processing procedure within equipment (hardware) such as a switching device but also be realized by software processing (signal processing program) using a general-purpose computer (personal computer, etc.) or computer within exclusive equipment. The signal processing program according to the embodiment is executed by CPU of the computer, stored in a storage medium such as CD-ROM and DVD-ROM, or delivered via communication lines such as Internet and LAN.

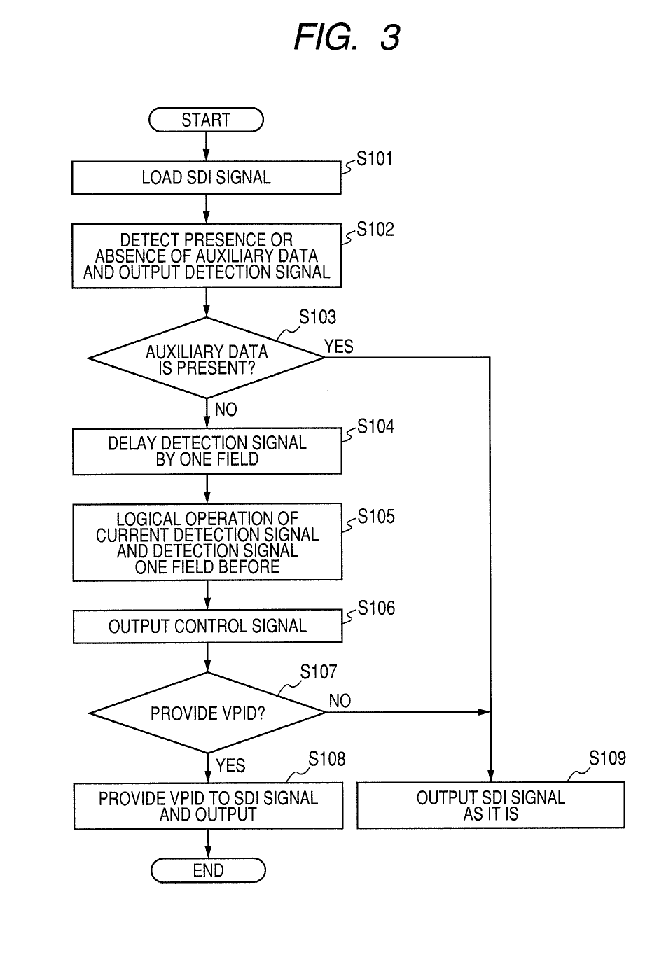

FIG. 3 is a flowchart for explanation of a flow of the signal processing program according to the embodiment. First, an SDI signal is loaded (step S101). Then, the SDI signal is converted into a parallel signal according to need, and then, whether there is auxiliary data or not is detected, and a detection signal is output (step S102).

Then, whether there is auxiliary data or not is determined according to the detection signal (step S103). If there is auxiliary data, the SDI signal is output as it is (step S109). Thereby, the SDI signal is output without the auxiliary data contained therein being destroyed.

On the other hand, if there is no auxiliary data, the current detection signal is delayed by one field (step S104). Then, the logical operation of the current detection signal and the detection signal one field before is performed (step S105), and the result of the logical operation is output as the control signal for VPID provision (step S106).

Then, whether or not the control signal commands VPID provision is determined (step S107). If the signal does not command provision, the SDI signal is output as it is (step S109) On the other hand, if the signal commands provision, VPID is provided to the SDI signal and the signal is output (step S108).

According to the signal processing program, VPID is provided to the SDI signal containing no ANCI (auxiliary data) and the SDI signal containing ANCI is output as it is without the existing ANCI destroyed.

### Second Embodiment

### <Signal Processing Device>

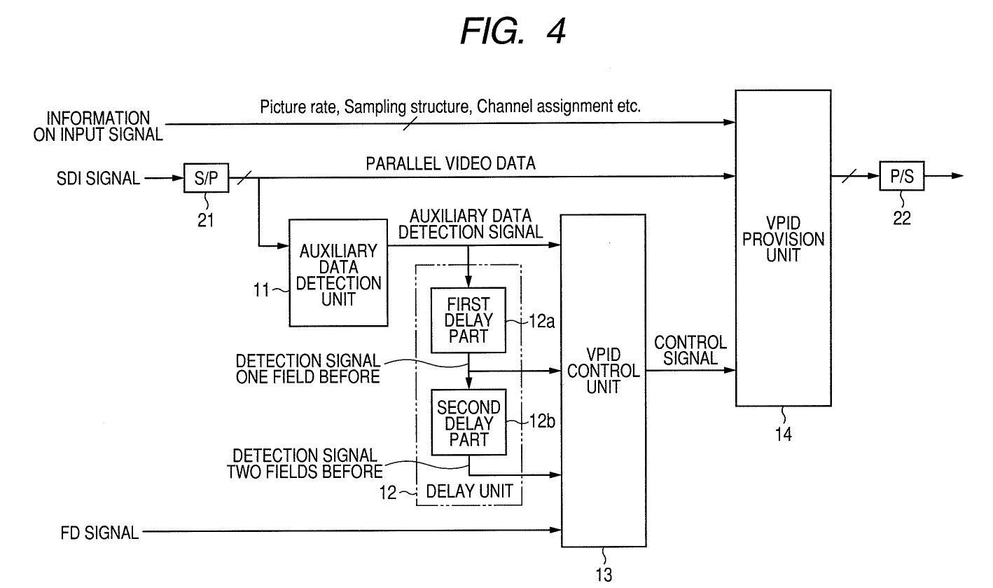

FIG. 4 is a block diagram for explanation of a signal processing device according to the second embodiment. The signal processing device according to the second embodiment mainly includes the auxiliary data detection unit 11, the delay unit 12 having a first delay part 12a and a second delay part 12b, the VPID control unit 13, and the VPID provision unit 14. Further, the signal processing device includes the serial-parallel conversion unit 21 that converts an SDI signal as serial video data into parallel video data, and the parallel-serial conversion unit 22 that converts parallel video data provided from the VPID provision unit 14 into serial video data.

The auxiliary data detection unit 11 inputs parallel video data converted from the SDI signal by the serial-parallel conversion unit 21, determines whether auxiliary data is contained in the SDI signal or not, and outputs a detection signal indicating the presence or absence of the auxiliary data. Specifically, the unit detects whether or not there is auxiliary data in a predetermined area in a line in a data stream in which VPID is supposed to be inserted in the SDI signal. More specifically, the unit refers to the horizontal auxiliary area at the immediate downstream of line CRC in the data stream of the 10-line and 572-line in 1080I (interlace) and 10-line in 720P and 1080P (progressive). The unit detects whether or not there is auxiliary data in the horizontal auxiliary area and outputs the result as a detection signal. The detection signal is output to the delay unit 12 and the VPID control unit 13.

The delay unit 12 is a circuit that delays the detection signal output from the auxiliary data detection unit 11 by at least one field. In the embodiment, the detection signal is delayed by one field by the first delay part 12a and output to the VPID control unit 13. Further, in the second delay part 12b, the detection signal that has been delayed by one field in the first delay part 12a is further delayed by one field, and the detection signal delayed by totally two fields is output to the VPID control unit 13.

The VPID control unit 13 outputs a control signal for controlling provision of VPID according to a logical operation with inputs of signals including the detection signal output from the auxiliary data detection unit 11, the detection signal one field before and the detection signal two fields before output from the delay unit 12, and an FD signal. Here, the FD signal is referred to as a signal indicating that the input SDI signal is in the 1st field or the 2nd field.

The VPID provision unit 14 adds VPID to a predetermined location of the SDI signal (parallel video data as the parallel-converted SDI signal in the embodiment) and output it if the control signal output from the VPID control unit 13 commands provision, and adds no VPID to the SDI signal (parallel video data as the parallel-converted SDI signal in the embodiment) and outputs it as it is if the control signal commands no provision.

Further, information representing contents of the VPID to be provided (information on the input signal) is sent to the VPID provision unit 14 when the VPID is provided. The information on the input signal is preset information of specifications of signals handled by the signal processing device and the like including Picture rate, Sampling structure, and Channel assignment, for example. The VPID provision unit 14 determines the contents of the VPID to be provided in conformity of the SMPTE-352M standard according to the information on the input signal.

### <Signal Processing Method>

First, the SDI signal is input to the serial-parallel conversion unit 21 for conversion into parallel video data. Here, in the parallel video data, one frame is configured by the 1st field and the 2nd field. The parallel video data is sent to the VPID provision unit 14 and the auxiliary data detection unit 11.

Then, in the auxiliary data detection unit 11, whether auxiliary data (ANC data: referred to as “ANCI” in the embodiment) of the SDI signal is contained in the sent parallel video data or not is determined. The LTC as a time code is contained in the ANCI. Specifically, whether or not there is auxiliary data in a predetermined area in a line in a data stream in which VPID is supposed to be inserted in the SDI signal is detected. More specifically, whether or not there is auxiliary data in the horizontal auxiliary area is determined by referring to the horizontal auxiliary area at the immediate downstream of line CRC in the data stream of the 10-line and 572-line in 1080I (interlace) and 10-line in 720P and 1080P (progressive).

If detecting ANCI, the auxiliary data detection unit 11 outputs a detection signal indicating the presence of the auxiliary data, and if detecting no ANCI, the unit outputs a detection signal indicating the absence of the auxiliary data. The detection signal is output to the delay unit 12 and the VPID control unit 13.

Then, the delay unit 12 performs processing of delaying the detection signal output from the auxiliary data detection unit 11 by one field using the first delay part 12a and further delaying the signal by one field (delaying by total two fields) using the second delay part 12b. The detection signal delayed by one field (the detection signal one field before) and the detection signal delayed by two fields (the detection signal two fields before) are sent to the VPID control unit 13.

Then, the VPID control unit 13 outputs a control signal for giving a command as to whether VPID is provided or not according to a predetermined logical operation with inputs of signals including the detection signal corresponding to the current field sent from the auxiliary data detection unit 11, the detection signal one field before and the detection signal two fields before sent from the delay unit 12, and the FD signal.

Subsequently, the VPID provision unit 14 provides VPID to the parallel video data according to the control signal output from the VPID control unit 13. That is, if the control signal commands provision, the unit provides VPID to the parallel video data. Specifically, VPID is provided to the horizontal auxiliary area (parallel video data corresponding to the horizontal auxiliary area) at the immediate downstream of line CRC in the data stream of the 10-line and 572-line in 1080I (interlace) and 10-line in 720P and 1080P (progressive). On the other hand, if the control signal commands no provision, the unit provides no VPID to the parallel video data and outputs it as it is.

Finally, the parallel video data output from the VPID provision unit 14 is sent to the parallel-serial conversion unit 22, and converted into the SDI signal as a serial signal and output.

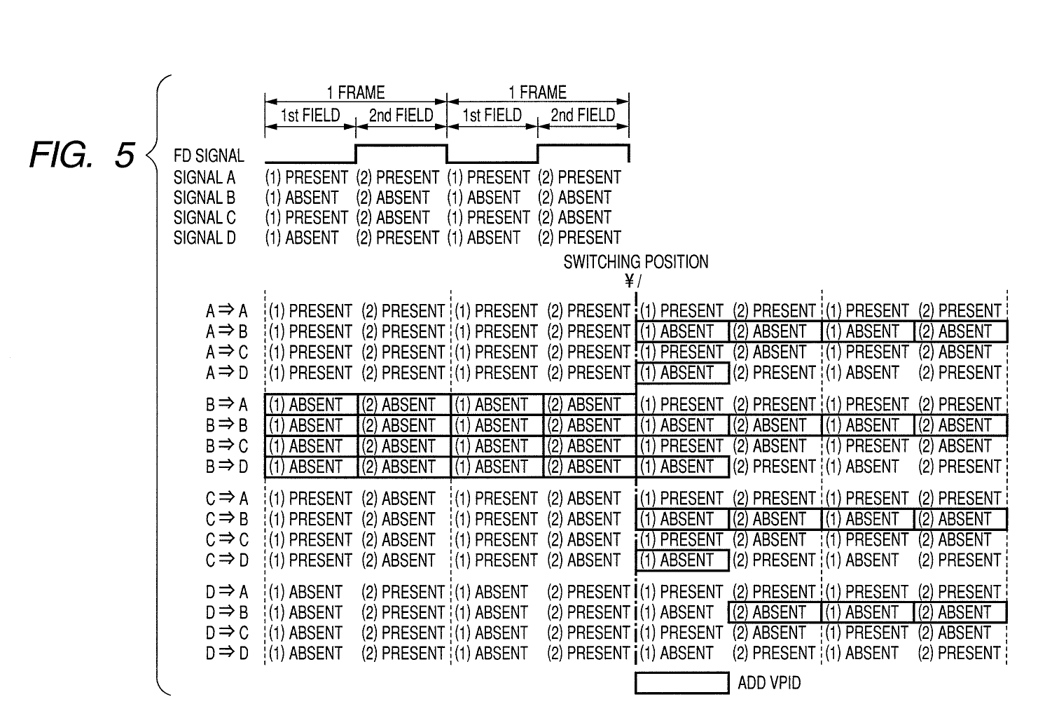

Here, the logical operation performed in the VPID control unit 13 will be explained. FIG. 5 is a diagram for explanation of the logical operation performed in the VPID control unit of the signal processing device according to the second embodiment. Here, the logical operation is for the case of applying the signal processing device according to the embodiment to a switching device that selects and outputs one of input SDI signals.

When the signal is switched in the switching device, there are four types of A to D of SDI signals before switching and SDI signals after switching. Signal A contains ANCI in both the 1st field and the 2nd field forming one frame, signal B contains no ANCI in both the 1st field and the 2nd field, signal C contains ANCI in the 1st field but contains no ANCI in the 2nd field, and signal D contains no ANCI in the 1st field but contains ANCI in the 2nd field.

Accordingly, when the four types of SDI signals are switched in the switching device, it is necessary to consider the total 16 patterns of signal variations from the four types before switching to the four types after switching.

Here, signal A is an SDI signal containing VPID like Dual Link and 3G-SDI, for example, because ANCI is contained in both the 1st field and the 2nd field.

Further, signal B is an SDI signal containing no VPID like HD and SD, for example, because no ANCI is contained in both the 1st field and the 2nd field.

Signal C is an SDI signal containing LTC (time code) in the 1st field, for example, because ANCI is contained in the 1st field but no ANCI is contained in the 2nd field.

Furthermore, signal D contains no ANCI in the 1st field but contains ANCI in the 2nd field, and such a signal is not used at present.

Of the 16 patterns of signal switching, regarding signal A to signal A, signal B to signal B, signal C to signal C, and signal D to signal D, the switching operation is not actually performed but the same signal passes through the switching position. Additionally, when the signal B is input, VPID is added before switching.

In the 16 patterns of switching of SDI signals, the logical operation performed in the VPID control unit 13 of the embodiment is to obtain the following operation result. Here, the detection information of the 1st field of the previous frame is P1, the detection information of the 2nd field of the previous frame is P2, the detection information of the 1st field of the current frame is N1, and the detection information of the 2nd field of the current frame is N2. As the detection information, if there is ANCI (auxiliary data), the information is “1”, and if there is no ANCI, the information is “0”. As the output (operation result), if VPID is provided, the control signal is “0”, and if no VPID is provided, the control signal is “1”.

The operation is as follows.

In the 1st field, the control signal=1 for P1=0, P2=1, and the control signal=N1 for other P1 and P2.

In the 2nd field, the control signal is OR (logical add) of N1 and N2 for any P1 and P2.

In the example shown in FIG. 5, VPID is provided in the fields indicated by thick frames. VPID provision in each switching of signals (including passing) is as follows.
From signal A to signal A: no VPID is provided in all fields.
From signal A to signal B: VPID is provided in the 1st field of the first frame after switching to signal B and the subsequent fields.
From signal A to signal C: no VPID is provided in all fields.
From signal A to signal D: VPID is provided only in the 1st field of the first frame after switching to signal D and no VPID is provided in all of the subsequent fields.
From signal B to signal A: VPID is provided in signal B before switching.
From signal B to signal B: VPID is provided in all fields.
From signal B to signal C: VPID is provided in signal B before switching.
From signal B to signal D: VPID is provided in signal B before switching and in the 1st field of the first frame after switching to signal D, but no VPID is provided in all of the subsequent fields.
From signal C to signal A: no VPID is provided in all fields.
From signal C to signal B: VPID is provided in the 1st field of the first frame after switching to signal B and the subsequent fields.
From signal C to signal C: no VPID is provided in all fields.
From signal C to signal D: VPID is provided only in the 1st field of the first frame after switching to signal D and no VPID is provided in all of the subsequent fields.
From signal D to signal A: no VPID is provided in all fields.
From signal D to signal B: VPID is provided in the 2nd field of the first frame after switching to signal B and the subsequent fields.
From signal D to signal C: no VPID is provided in all fields.
From signal D to signal D: no VPID is provided in all fields.

In the logical operation, in switching from signal A to signal B and switching from signal C to signal B, VPID is provided in the 1st field of the first frame after switching and all of the subsequent fields.

On the other hand, in switching from signal A to signal D, switching from signal B to signal D, and switching from signal C to signal D, VPID is provided only in the 1st field of the first frame after switching, and in switching from signal D to signal B, no VPID is provided in the 1st field of the first frame after switching. However, it is not necessary to substantially consider the operation results because all of them contain signal D as a subject of switching and signal D is not used at present.

It is known that, in the second embodiment, VPID can be added immediately after switching from signal A and signal B, and more appropriate VPID provision processing than that in the first embodiment is realized.

In the above explanation, the case of applying the signal processing device of the embodiment to the switching device has been taken as an example. In the device without switching (the device with the same types of input and output signals), only the operation in the cases from signal A to signal A, signal B to signal B, signal C to signal C, and signal D to signal D is used in the above logical operations. In all of the cases, if there is ANCI in the input SDI signal, the signal is output as it is without VPID provided (but with ANCI), and if there is no ANCI in the input SDI signal, the signal is output after VPID is provided in the 1st field of the first frame and VPID is provided in all of the subsequent fields.

### <Signal Processing Program>

The signal processing method according to the embodiment may not only be executed as a processing procedure within equipment (hardware) such as a switching device but also be realized by software processing (signal processing program) using a general-purpose computer (personal computer, etc.) or computer within exclusive equipment. The signal processing program according to the embodiment is executed by CPU of the computer, stored in a storage medium such as CD-ROM and DVD-ROM, or delivered via communication lines such as Internet and LAN.

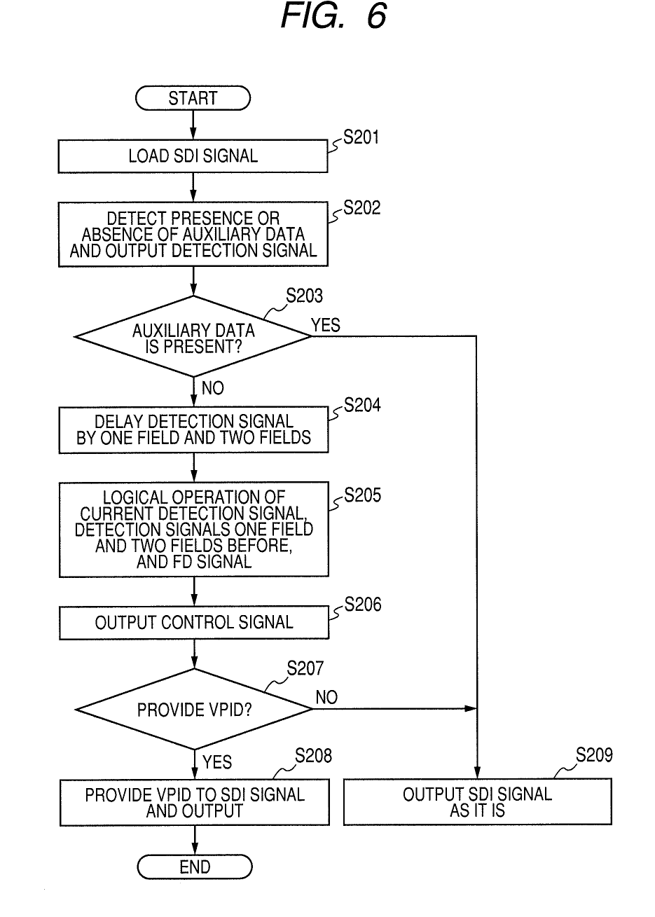

FIG. 6 is a flowchart for explanation of a flow of the signal processing program according to the embodiment. First, an SDI signal is loaded (step S201). Then, the SDI signal is converted into a parallel signal according to need, and then, whether there is auxiliary data or not is detected, and a detection signal is output (step S202).

Then, whether there is auxiliary data or not is determined according to the detection signal (step S203). If there is auxiliary data, the SDI signal is output as it is (step S209). Thereby, the SDI signal is output without the auxiliary data contained therein being destroyed.

On the other hand, if there is no auxiliary data, the current detection signal is delayed by one field and by two fields (step S204). Then, the logical operation of the current detection signal and the detection signal one field before and the detection signal two fields before is performed (step S205), and the result of the logical operation is output as the control signal for VPID provision (step S206).

Then, whether or not the control signal commands VPID provision is determined (step S207). If the signal does not command provision, the SDI signal is output as it is (step S209) On the other hand, if the signal commands provision, VPID is provided to the SDI signal and the signal is output (step S208).

According to the signal processing program, VPID is provided to the SDI signal containing no ANCI (auxiliary data) and the SDI signal containing ANCI is output as it is without the existing ANCI destroyed.

### <Application Example>

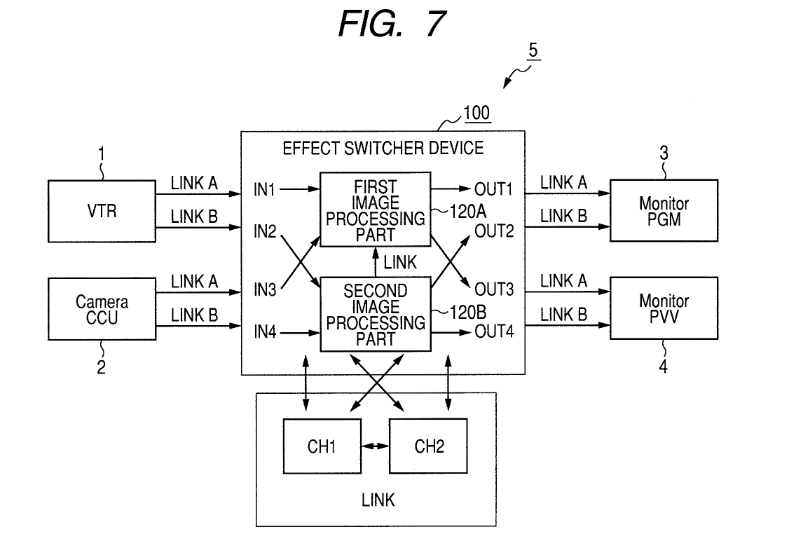

The embodiments of the invention are applied to an effect switcher device, for example. FIG. 7 is a block diagram for explanation of the effect switcher device. An effect switcher device 100 is applied to an image processing system 5 that performs wiping processing on image signals supplied via dual link from an image reproducing device 1 and an imaging device 2 with a first image processing part 120A and a second image processing part 120B and outputs the signals to monitors 3, 4 via dual link.

CH1 and CH2 shown in FIG. 7 are digital special effect units for special effects such as scaling and deformation of images. The units have circuits for temporarily writing input image signals in a memory, and form output images by performing coordinate transform or the like on an entry screen and output the images.

FIG. 7 schematically shows the input and output connection such that the first image processing part 120A may process the link A side and the second image processing part 120B may process the link B side. Further, an arrow of link shows that the second image processing part 120B is controlled through linkage with the control of the first image processing part 120A.

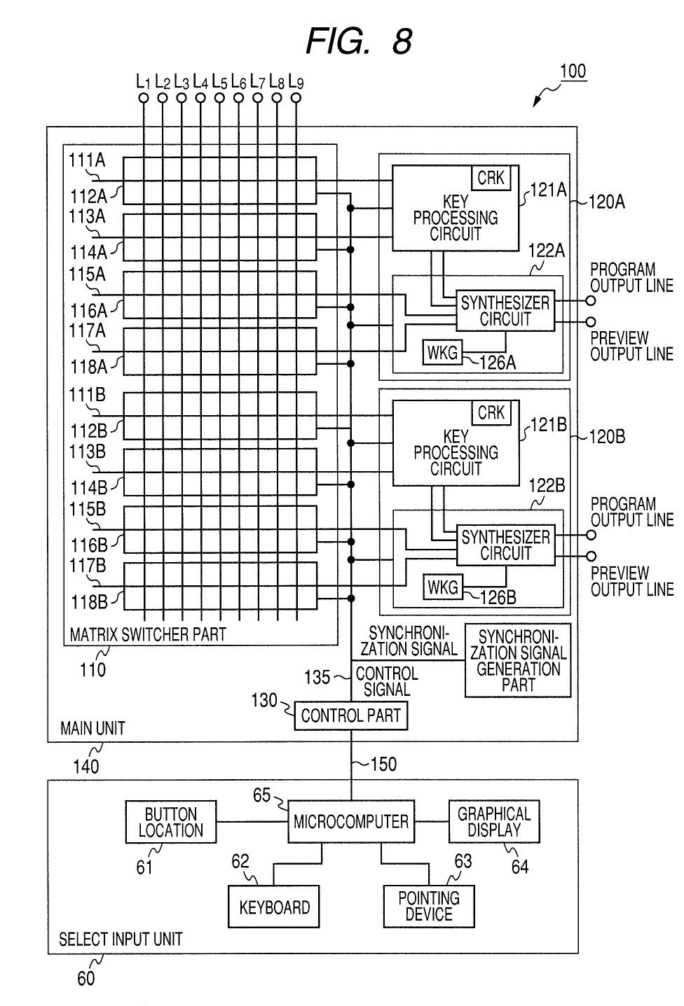

The effect switcher device 100 includes, as shown in FIG. 8, for example, a main unit 140 having a matrix switcher part 110 that selects video signals input to input lines L1 to L9, the first image processing part 120A to which the video signals input to input lines L1 to L9 are supplied via the matrix switcher part 110, the second image processing part 120B to which the video signals input to input lines L1 to L9 are supplied via the matrix switcher part 110, and a control part 130 for control of the parts, and a select input unit 60 connected to the control part 130 of the main unit 140 via a communication channel 150.

In the effect switcher device 100, video signals as key source signals or key fill signals are input to the input lines L1 to L9.

The matrix switcher part 110 has a key source intersection row 112A including switches for connection to a key source signal select input bus 111A that supplies one of the video signals input to input lines L1 to L9 as a key source signal to the first image processing part 120A.

Further, the matrix switcher part 110 has a key fill intersection row 114A including switches for connection to a key fill signal select input bus 113A that supplies one of the video signals input to input lines L1 to L9 as a key fill signal to the first image processing part 120A.

Furthermore, the matrix switcher part 110 has a first background intersection row 116A including switches for connection to a first background signal select input bus 115A that supplies one of the video signals input to input lines L1 to L9 as a first background signal to the first image processing part 120A.

Moreover, the matrix switcher part 110 has a second background intersection row 118A including switches for connection to a second background signal select input bus 117A that supplies one of the video signals input to input lines L1 to L9 as a second background signal to the first image processing part 120A.

The matrix switcher part 110 has a key source intersection row 112B including switches for connection to a key source signal select input bus 111B that supplies one of the video signals input to input lines L1 to L9 as a key source signal to the second image processing part 120B.

Further, the matrix switcher part 110 has a key fill intersection row 114B including switches for connection to a key fill signal select input bus 113B that supplies one of the video signals input to input lines L1 to L9 as a key fill signal to the second image processing part 120B.

Furthermore, the matrix switcher part 110 has a first background intersection row 116B including switches for connection to a first background signal select input bus 115B that supplies one of the video signals input to input lines L1 to L9 as a first background signal to the second image processing part 120B.

Moreover, the matrix switcher part 110 has a second background intersection row 118B including switches for connection to a second background signal select input bus 117B that supplies one of the video signals input to input lines L1 to L9 as a second background signal to the second image processing part 120B.

The first image processing part 120A includes a key processing circuit 121A and a synthesizer circuit 122A.

The key processing circuit 121A is connected to the key source signal select input bus 111A and the key fill signal select input bus 113A. To the key processing circuit 121A, the key source signal and the key fill signal selected from the video signals input to input lines L1 to L9 are input via the key source signal select input bus 111A and the key fill signal select input bus 113A.

Then, the key processing circuit 121A performs processing of generating a key signal according to the control signal from the control part 130 with the input key source signal or a built-in waveform generator circuit (wipe pattern generation circuit). Then, the key processing circuit 121A supplies the key signal and the key fill signal to the synthesizer circuit 122A.

The synthesizer circuit 122A is connected to the key processing circuit 121A and connected to the first background signal select input bus 115A and the second background signal select input bus 117A.

To the synthesizer circuit 122A, the key signal and the key fill signal are input from the key processing circuit 121A. Further, to the synthesizer circuit 122A, the first background signal and the second background signal selected from the video signals input to input lines L1 to L9 are input via the first background signal select input bus 115A and the second background signal select input bus 117A.

Then, the synthesizer circuit 122A performs processing of synthesizing a key fill signal (keying processing) by replacing an area represented by the key signal provided from the key processing circuit 121A with the first background signal or the second background signal.

The second image processing part 120B includes a key processing circuit 121B and a synthesizer circuit 122B.

The key processing circuit 121B is connected to the key source signal select input bus 111B and the key fill signal select input bus 113B. To the key processing circuit 121B, the key source signal and the key fill signal selected from the video signals input to input lines L1 to L9 are input via the key source signal select input bus 111B and the key fill signal select input bus 113B.

Then, the key processing circuit 121B performs processing of generating a key signal according to the control signal from the control part 130 with the input key source signal or a built-in waveform generator circuit (wipe pattern generation circuit). Then, the key processing circuit 121B supplies the key signal and the key fill signal to the synthesizer circuit 122B.

The synthesizer circuit 122B is connected to the key processing circuit 121B and connected to the first background signal select input bus 115B and the second background signal select input bus 117B.

To the synthesizer circuit 122B, the key signal and the key fill signal are input from the key processing circuit 121B. Further, to the synthesizer circuit 122B, the first background signal and the second background signal selected from the video signals input to input lines L1 to L9 are input via the first background signal select input bus 115B and the second background signal select input bus 117B.

Then, the synthesizer circuit 122B performs processing of synthesizing a key fill signal (keying processing) by replacing an area represented by the key signal provided from the key processing circuit 121B with the first background signal or the second background signal.

In the above explanation, the key signal is binary and the background signal or the key fill signal is designated, however, more specifically, the key signal is not binary but represents density, and the density when the key fill signal is superimposed on the background signal is expressed in multiple values. Therefore, image processing can be performed to provide an image in which a background is seen with a part of key fill signal semi-transmissively visible.

Furthermore, the control part 130 includes a microcomputer, and generates a control signal according to the select input signals provided from the select input unit 60 via the communication channel 150 and controls the respective operations of the matrix switcher part 110, the first image processing part 120A and the second image processing part 120B via a control line 135.

The select input unit 60 includes a microcomputer 65 to which a button location 61, a keyboard 62, a pointing device 63 such as a mouse, a graphical display 64, and so on are connected.

When input selection is operated with the button on the button location 61, the matrix switcher part 110 of the main unit operates to select a pair of inputs at A side and B side, respectively. For example, when input L1 is at the link A side of the first image signal and input L2 is at the link B side of the first image signal, if the selection of the first image signal is operated for the first background, the part performs operation to select L1 in the first background intersection row 116A and select L2 in the first background intersection row 116B. The part performs the same operation for the other input pairs and intersection rows. When an interlace image is handled in the same device, such switching in pairs is not performed but switching may be performed in one-to-one correspondence to the operation.

In the effect switcher device 100, the select input unit 60 communicates with the control part 130 of the main unit 140 via the communication channel 150 and commands execution of various kinds of processing.

The synthesizer circuit 122A receives input of the background signals from the first background signal select input bus 115A and the second background signal select input bus 117A, and uses one of the background signals or synthesizes the two background signals at the commanded ratio by the commanded synthesizing method according to the command from the select input unit 60 as the background signal after synthesis used for keying processing.

The ratio may be manually commanded by a fader lever in the select input unit or the like, or, in the case of automatic transition (automatic progress) operation, controlled to change with time from one background signal to the other background signal.

The synthesizing method, as mixing, for example, performs weighting addition on the two background signals at the ratio with respect to each pixel (e.g., if the ratio is 30%, the value obtained by multiplication of the first background signal by 0.3 and the value obtained by multiplication of the second background signal by 0.7 are added).

Alternatively, another example of the synthesizing method, as wiping, performs processing of superimposing the second background signal on the first background signal by keying using a key signal for wiping supplied from a wipe key waveform generation circuit (WKG: Wipe Key Generator) 126A in FIG. 8. The key signal generated by the wipe key waveform generation circuit 126 changes with the ratio and, in automatic transition, the signal is generated to determine the boundary line of the wiping using progress time t as a input parameter. Not in automatic transition, the commanded ratio is used in place of t.

The above method is the same as that for the synthesizing circuit 122B.

The signal processing device of the embodiment is incorporated in the first image processing part 120A and the second image processing part 120B in the effect switcher device 100 described above and appropriately provides VPID according to need using the above explained logical operation in switching (transmission) of the input SDI signal (link A, link B).

### Advantages of Embodiments

When VPID is provided to video data of SDI signals, appropriate provision processing can be performed by referring to several fields based on presence or absence information of auxiliary data in the VPID definition position. Further, appropriate provision processing can be also performed not only on normal SDI signals but also signals after switching of some kinds of SDI signals. Furthermore, more appropriate provision processing can be performed by referring to several fields. Since the amount of delay in processing within the device is very small, the device can be mounted in equipment such as a switching device that may require short waiting time for processing.

Moreover, at accidents of disconnection of input signals or the like, VPID can correctly be added to the output SDI signals. Further, even when VPID is lost at the upstream of the equipment, VPID can correctly be added.

The present application contains subject matter related to that disclosed in Japanese Priority Patent Application JP 2008-130809 filed in the Japan Patent Office on May 19, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A signal processing device comprising:
an auxiliary data detection unit that detects presence or absence of auxiliary data from an SDI (Serial Digital Interface) signal and outputs a detection signal indicating the presence or absence of auxiliary data;
a delay unit that delays the detection signal output from the auxiliary data detection unit by at least one field;
a payload identifier control unit that outputs a control signal for controlling provision of payload identifier according to a logical operation with signals including the detection signal output from the auxiliary data detection unit and the detection signal delayed by the delay unit; and
a payload identifier provision unit that adds a payload identifier to the SDI signal and outputs the signal if the control signal output from the payload identifier control unit commands provision, and adds no payload identifier to the SDI signal and outputs the signal as it is if the control signal commands no provision.

2. The signal processing device according to claim 1, wherein the delay unit delays the detection signal output from the auxiliary data detection unit by one field or two fields, and
the payload identifier control unit outputs the control signal according to a logical operation of the detection signal output from the auxiliary data detection unit, the detection output from the delay unit, and a field identification signal indicating the first field and the second field of one frame.

3. The signal processing device according to claim 1, wherein information representing contents of the payload identifier is input to the payload identifier provision unit.

4. The signal processing device according to claim 1, wherein, in the logical operation of the payload identifier control unit, the control signal commanding provision of the payload identifier is output if the detection signal indicating the absence of the auxiliary data is output from the auxiliary data detection unit, and the control signal commanding no provision of the payload identifier is output if the detection signal indicating the presence of the auxiliary data is output.

5. The signal processing device according to claim 1, wherein the payload identifier provision unit provides the payload identifier to all fields of the SDI signal when providing the payload identifier.

6. A signal processing method comprising the steps of:
detecting presence or absence of auxiliary data from an SDI (Serial Digital Interface) signal and outputting a detection signal indicating the presence or absence of auxiliary data;
delaying the detection signal by at least one field;
outputting a control signal for controlling provision of payload identifier according to a logical operation with signals including the detection signal of the current field based on the SDI signal and the detection signal delayed by a predetermined number of fields; and
adding a payload identifier to the SDI signal and outputting the signal if the control signal commands provision, and adding no payload identifier to the SDI signal and outputting the signal as it is if the control signal commands no provision.

7. A signal processing program allowing a computer to execute the steps of:
detecting presence or absence of auxiliary data from an SDI (Serial Digital Interface) signal and outputting a detection signal indicating the presence or absence of auxiliary data;
delaying the detection signal by at least one field;
outputting a control signal for controlling provision of payload identifier according to a logical operation with signals including the detection signal of the current field based on the SDI signal and the detection signal delayed by a predetermined number of fields; and
adding a payload identifier to the SDI signal and outputting the signal if the control signal commands provision, and adding no payload identifier to the SDI signal and outputting the signal as it is if the control signal commands no provision.
